(19) United States
(12) Patent Application Publication
(10) Pub. No.: US 2005/0112421 A1
(43) Pub. Date: May 26, 2005

(54) Fuel cell device

(76) Inventor: Gesine Arends, Gerlingen (DE)

Correspondence Address: STRIKER, STRIKER & STENBY, 103 EAST NECK ROAD, HUNTINGTON, NY, 17743, US

(21) Appl. No.: 10/960,728

(22) Filed: Oct. 7, 2004

(30) Foreign Application Priority Data
Oct. 9, 2003 (DE) 10346840.4

(51) Int. Cl. H01M 8/18; H01M 8/04; H01M 8/12

(52) U.S. Cl. 429/19; 429/20; 429/26

(57) ABSTRACT

A fuel cell device has a fuel cell, a reformer for fuel reformation for the fuel cell, a process water conduit for a supplying of process water separately from another educt stream or educt streams, a burner for supplying a process heat for the reformer, and at least one short circuiting conduit for a circulating circuit of the process water.

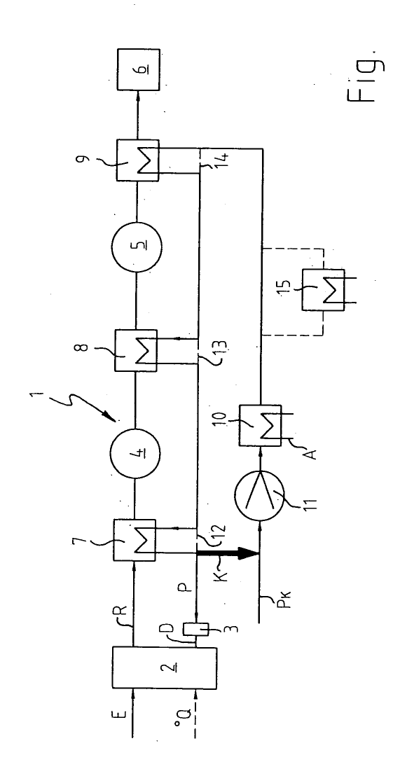

### BACKGROUND OF THE INVENTION

The present invention generally relates to fuel cell devices.

In fuel cell devices with a fuel reformer, a heat source, as a rule a burner, is utilized for bringing the reformer or the educt streams introduced in into the reformer to the required operational temperature.

The waste heat of the burner is generally used via a heat exchanger, for example for heating the educt streams on the way to the reformer. Also, the waste heat of the reformate gas supplied from the reformer is used in a corresponding manner. These waste heat uses serve for improvement of the efficiency of the total device. Frequently in the fuel cell devices the waste heat use is provided by heat transfer between the corresponding gas flows.

### SUMMARY OF THE INVENTION

Accordingly, it is an object of the present invention to provide a fuel cell device in which the waste heat is used in particular during the heating phase in an improved manner and possibly reduces the heating phase.

In keeping with these objects and with others which will become apparent hereinafter, one feature of the present invention resides, briefly stated in a fuel cell device, comprising a fuel cell; a reformer for fuel reformation for said fuel cell; a process water conduit for a supply of process water separately from an educt stream or educt streams; a burner for supplying process heat for said reformer; and at least one short circuiting conduit for a circulating circuit of the process water.

In a fuel cell device in accordance with the present invention at least one short circuiting conduit is provided for a circulating circuit of the process water. With this feature thermal energy is transported from warmer to colder device components, so that in particular the heating phase is significantly shortened or the heating is substantially accelerated.

In this circulating circuit, advantageously in accordance with the invention the process water or at least a part of the process water is recirculated many times.

It is advantageous that the waste heat of the burner waste gas can be used by a preferable coupling into the preheating circulation in accordance with the present invention.

In some cases the process water serves to a certain extent as a heat transmitter for transmitting the thermal energy from warmer to colder components or as an energy storage of the waste heat received from the burner gas and/or the above mentioned heat exchanger.

In the case when no or only little process water is required, generally exothermal reaction does not take place. During this time in particular in the initial phase no waste heat is removed, so that the reached temperature level is maintained.

Moreover, in accordance with the present invention a heat exchanger is provided for thermal coupling of process water and the burner off-gas. The use of the process water as a cooling medium in the heat exchanger for waste heat utilization of the burner off-gas provides the advantage that a heat transfer from a solid matter to a liquid medium is substantially more effective than a heat transfer from a solid matter to a gas. In the heat exchanger, due to the separate liquid conduits of the different media, at least two heat transfers take place. A heat transfer between the flue gas and the wall of the heat exchanger on one hand is provided, and a heat transfer between the wall and the process water is provided on the other hand. With the utilization of the process water as a cooling medium, an improved waste heat use is possible.

In a preferable embodiment of the present invention, in addition a heat exchanger for thermal coupling of the process water with the reformate gas from the reformer is provided. As considered in the flow direction of the process water, it is located after the first heat exchanger which is thermally coupled with the burner waste gas.

Also, in the second heat exchanger, correspondingly it is advantageous that the improved heat transfer is performed to the liquid process water, when compared with transfer to a gaseous educt stream or the like.

Moreover, it is advantageous when in accordance with the present invention a water pump is provided, which is located before the first heat exchanger thermally coupled with the burner waste gas. The thusly arranged water pump can be fed directly from the process water supply. This has the advantage that a flow to the water pump with liquid, cold water also is guaranteed when the heating of the process water in a heat exchanger is performed in the vicinity of the boiling point or above it. By the process water supply the liquid water continuously feeds the water pump. The evaporation of the process water downstream of the water pump is not critical since the process water is supplied to the reformer or in some cases to similar reactors and also conventionally to the fuel cell in vapor condition anyway.

In an advantageous further embodiment of the invention, several heat exchangers are provided and located after the first heat exchanger that is thermally coupled with the burner waste gas. With such additional heat exchangers, by the same process water conduit a waste heat from further reactors located after the reformer can be utilized. Such reactors which as a rule have different operational temperatures are conventionally located after the fuel reformer for preparation or for purification of the reformate gas. In this case some carbon monoxide located in the reformate gas can be oxidized in steps to carbon dioxide, whereas however an additional reaction heat is produced. This additional reaction heat is used in advantageous manner via the additional heat exchanger or heat exchangers for heating the process water.

Moreover, such a heat exchanger can be used also for utilization of waste heat produced during cooling of the fuel supplied to the fuel cell to the operational temperature of the fuel cell.

For the utilization of reaction heat from the reactors which are located after the reformer, it is recommended to arrange between such reactors a heat exchanger, for bringing the reformate gas subjected in the reactor to an additional heating, to a desired lower temperature for the next reaction step. Moreover, with such a stepped sequence of the reactors and heat exchangers, the heat utilization is improved.

For ensuring that the water pump is always supplied with flowing water in the partial or full circulation circuit, it is advantageous to provide a bypass conduit preferably on at least one heat exchanger, in an advantageous embodiment preferably on several or all heat exchangers, for bridging the heat exchanger. These bypass conduits can be activated individually or jointly when the temperature of the process water reaches the boiling point, or in other words 100° C., so that the pump in every case is fed vapor-free.

Moreover, these bypass conduits can be used also for regulation of different temperature stages on the way of the reformate gas from the reformer to the fuel cell. The bypass conduits can be opened, closed, or also varied with respect to the volume stream by corresponding regulating valves. Also, the short circuiting conduit for the circulation circuit of the process water can be used for the purpose of a control or regulation of the temperature in the process water or the different temperature stages on the way of the reformate gas to the fuel cell, or in other words the temperature in the different reactors or cleaning stages arranged after it.

Basically it is also recommended to introduce into the process water conduit a cooler which is bridged in some cases by a bypass. Such a cooler can be formed also for example as a heat exchanger for external waste heat utilization, for example for tap water or other applications.

With the different bypass conduits as well as the circulating circuit, in particular in connection with corresponding regulating valves, a great flexibility in the heat transportation and the heat utilization is provided both for the burner waste gas and the reformate gas.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing a fuel cell device in accordance with the present invention.

### DESCRIPTION OF THE PREFERRED EMBODIMENTS

A fuel cell device in accordance with the present invention is identified as a whole with reference numeral 1. It includes a fuel reformer 2 to which an educt stream E is supplied, for example in form of one or several hydrocarbon containing materials, as well as vapor D which is recovered by an evaporator 3 from process water P. Furthermore, a heat quantity Q is supplied to the reformer 2, which is provided for example via a burner (not shown). The evaporator 3 is heated generally by burner waste gases in a manner not shown.

The reformate gas in the shown embodiment passes through two purification stages in form of reactors 4 and 5, before it is supplied to a fuel cell 6. The reformate gas R is cooled in steps to an operational temperature of the fuel cell 6 from its original temperature acting in the reformer 2. For this purpose three heat exchangers 7, 8, 9 are provided. The cooling of the respective components is performed substantially to the operational temperature of the reactor or device element located after it. Normally, the heat exchanger 9 serves for cooling to the operational temperature.

A further heat exchanger 10 serves in accordance with the present invention for a waste heat utilization or residual heat utilization from the waste gas A substantially cooled through the heat utilization in the reformer 2 or the evaporator 3, of one or several not shown heat sources, for example of the burner which provides the heat quantity Q.

A water pump 11 is arranged before the heat exchanger 10 for waste heat utilization of the burner waste gas. It is supplied with colder process water from a process water supply P_{K}.

A short circuiting conduit K is identified with an arrow. It serves for producing a circulating circuit of the process water P.

A bypass 12, 13, 14 is identified with point lines at the heat exchangers 7, 8, 9. An optional heat exchanger 15 is identified by dashes indicating connecting conduits.

The inventive heat exchanger 10 serves for heat transfer of the conventionally somewhat cooled burner waste gas A to the cold consumer water P_{K}, which is conveyed by the water pump 11. By the utilization of liquid, cold process water as a cooling medium, most part of the burner waste heat is transmitted to the process water conduit.

Finally, the process water is supplied into the heat exchanger 9, for cooling the fuel reformate R to the operational temperature of the fuel cell 6.

Therefore, the heat produced in the reactor 5 for preparation of the reformate gas is also used for heating of the process water.

In the subsequent heat exchanger 8 the reformate gas stream R is brought to the inlet temperature required for the operation of the reactor 5. With the heat exchanger 4, the reaction heat produced in the reactor 4 is also supplied to the process water.

In the heat exchanger 7 a part of the heat produced by the reaction in the reformer 2 as well as the supplied heat Q is drawn from the reformate gas R, to bring it to the lower temperature desired for the operation of the reactor 4. Also, this waste heat is used correspondingly for heating of the process water. Subsequently, the process water P is supplied in some cases through the evaporator 3 in form of the water steam D, into the reformer 2.

In a conventional device during the normal operation the burner waste gas is first used for preheating of the hot process vapor/natural gas mixture before the reformer. This is identified by the dash arrow Q in the reformer 2. The burner waste gas that subsequently is very hot, can be used at another location before coupling it into the conduit of the cold process water Pₖ via the heat exchanger D.

In particular, during start-up operation the burner waste gas can be first used also for prewarming of the educt streams, before it is coupled into the process water circle.

The process water circle, because of the heat capacity of the liquid process water, can receive a relatively great heat quantity. Moreover, the heat from the reactor body to the liquid water is better than to a gaseous cooling medium. By the heat transfer to the process water P, which subsequently before the use must be warmed or evaporated in the reformer 2, this waste heat is used for an improved efficiency in advantageous manner.

The bypass conduits 12, 13, 14, as well as the short circuiting circuit through the short circuiting conduit K provide a greater flexibility in heat transportation and during the adjustment of the operational temperature desired at the respective location. In some cases corresponding regulating valves can be integrated in the bypass conduits 12, 13, 14. Also, the short circuiting conduit K can be opened or closed completely or partially by a regulating valve.

When the process heat supplied to the process water P is too high, optionally an additional heat exchanger 15 can be provided for external waste heat utilization. The heat exchanger 15 serves in the process water conduit as a cooler, that is however provided or used when needed. In particular, such a cooling is required in certain conditions to avoid an excessive heating of the process water P. Basically, it is necessary to take care that the water pump 11 is always fed with liquid water.

This is the case as a rule with the arrangement before the heat exchanger 10 as well as the subsequent heat exchangers 7, 8, 9. The water pump 11 normally is supplied with cold process water, so that there is no danger of a vapor action.

An overheating of the process water above the boiling point, in particular in short circuiting or circulating operation, can be moreover prevented by a short circuiting of one or several heat exchangers 7, 8, 9, as long as the desired temperature intervals for the fuel cell in the reformate gas stream are not left.

Basically, for optimal heat utilization the waste heat quantities generated during the cooling of the product gas between the reactors are used for prewarming of the required process water or vapor. By the short circuiting in the process water guidance, in an advantageous manner a circulation through the heat exchanger is obtained, without a further pump. The realized circulation is heated with the burner waste gas and/or transports the heat energy from high temperature to low temperature region of the device. Thereby the heat exchanger can be heated exactly under 100C, so that the water enters the pump in liquid form. When a heat exchanger becomes hotter by another heat supply, then it is removed from the circulation by short circuiting or bypass.

The inventive utilization of the process water P_{K} for waste gas heat use makes possible a very good useful heat utilization and thereby a high efficiency of the fuel cell device 1. The flexibility of this waste heat use is improved by further features alone or in their combination with one another. In particular, also a regulation of the temperature stages in the reformate gas stream is possible by the above mentioned features pertaining to special embodiments. Important in the invention is first of all the short circuiting conduit K and the possibility connected therewith for significantly shortening the heating, start-up or initial phase by circulation guidance of the process water.

It will be understood that each of the elements described above, or two or more together, may also find a useful application in other types of constructions differing from the types described above.

While the invention has been illustrated and described as embodied in a fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A fuel cell device, comprising a fuel cell; a reformer for fuel reformation for said fuel cell; a process water conduit for a supply of process water separately from another educt stream or educt streams; a burner for supplying a process heat for said reformer; and at least one short circuiting conduit for a circulating circuit of the process water.

2. A fuel cell device as defined in claim 1; and further comprising at least one a heat exchanger for thermal coupling of the process water with burner waste gas.

3. A fuel cell device as defined in claim 2; and further comprising a heat exchanger for thermal coupling of the process water with a reformate from said reformer, which in a flow direction of the process water is connected after a first one of heat exchangers.

4. A fuel cell device as defined in claim 2; and further comprising a water pump located before said heat exchanger which is a first heat exchanger, for coupling of a burner waste gas with the process water.

5. A fuel cell device as defined in claim 1; and further comprising a plurality of further heat exchangers arranged after said heat exchanger which is a first heat exchanger, for a burner waste gas coupling.

6. A fuel cell device as defined in claim 1; and further comprising a plurality of heat exchangers arranged after said heat exchanger which is a first heat exchanger for a burner waste gas coupling, said further heat exchangers being thermally coupled with a reformate gas.

7. A fuel cell device as defined in claim 1; and further comprising at least one reactor for processing of a reformate gas.

8. A fuel cell device as defined in claim 1; and further comprising a plurality of reactors for processing of a reformate gas.

9. A fuel cell device as defined in claim 7; and further comprising a heat exchanger for thermal coupling of the process water with the reformate gas and arranged after a unit selected from the group consisting of said reformer, said at least one reactor for processing of reformate gas and both when considered in a flow direction of the reformate gas.

10. A fuel cell device as defined in claim 1; and further comprising a bypass for short circuiting of a heat exchanger in a process water conduit.

11. A fuel cell device as defined in claim 1; and further comprising a plurality of heat exchangers each provided with a bypass.

12. A fuel cell device as defined in claim 1; and further comprising a heat exchanger provided for external waste heat use and connected with the process water conduit.
